(19) United States
(12) Patent Application Publication
(10) Pub. No.: US 2021/0358471 A1
(43) Pub. Date: Nov. 18, 2021

(54) METHOD AND SYSTEM FOR PREVENTING OVERHEARING OF PRIVATE CONVERSATIONS

(71) Applicant: David LIEBER, Springfield, IL (US)

(72) Inventor: David LIEBER, Springfield, IL (US)

(21) Appl. No.: 15/930,294

(22) Filed: May 12, 2020

(51) Int. Cl. G10K 11/175; G06Q 50/26; G07C 9/38; G06K 7/10; G07C 1/02; G06F 3/16

(52) U.S. Cl. CPC G10K 11/1754; G06Q 50/265; G07C 9/38; G06Q 30/0261; G07C 1/02; G06F 3/165; G06K 7/10297

(57) ABSTRACT

A method and system to obscure inappropriate sounds and ensure privacy in conversations through Near Field communication. The method includes applying a passive NFC tag on a first object associated to an individual who advances inside an enclosed area designed for a specific purpose. Further, the method includes activating an NFC reader on a second object when the first object and the second object are within a short range. Furthermore, the method includes sending a signal to a WIFI router wherein the signal speaks to a speaker module inside the enclosed area. Moreover, the method includes automatically streaming sound files, from a storage, thereby making it difficult for the individual inside the enclosed area to hear private conversations between two or more people due to a fogging sound effect produced by the sound files.

### TECHNICAL FIELD

Embodiments of the disclosure relate generally to the field of privacy systems. Embodiments relate more particularly to a method and system for preventing overhearing of private conversations through Near Field Communication.

### BACKGROUND

Eavesdropping, or the act of listening to conversations of those around us is not an intentional choice or character flaw, but a habit that we are wired for. There is a sequence of scenarios in which it is important to maintain privacy in conversations. For instance, Health Insurance Portability and Accountability Act of 1996 (HIPPA) mandates that healthcare organizations take reasonable measures to safeguard confidential and sensitive personal and medical information. This includes conversations with physicians in their offices, hospital registration areas, nursing stations, insurance service call centers, the offices of human resources representatives and even discussions between an attorney and client.

Specifically, the conversation between the physician and the patient in the consultation room is concerned with the privacy of the patient and must not be heard by others. In recent years, the importance of privacy protection in medical settings has been raised. However, in an actual hospital or clinic, it is difficult to completely separate the examination room from the waiting room and the treatment room with a soundproof structure.

Generally, rooms are available to allow people to have private conversations. For instance, privacy rooms are often provided in healthcare facilities, such as hospitals and meeting rooms are often available in courthouses for attorneys to meet with their clients. Despite the availability of such rooms, some discussions are not kept private due to several reasons. This is not preferable from the viewpoint of privacy protection. The reason for this is that the walls of the examination room and the consultation room are thin, use of an open low partition near the ceiling or a thin wall partition, or simply partition with curtains, ineffective acoustical treated ceilings and so on. The so-called soundproof ceilings in reality do not completely absorb speech frequency sound energy. Similarly, many exam rooms are thin walled and most people have an experience of over-hearing conversations or experiences that may not be appropriate for them to hear through these walls.

As another current strategy to address overhearing of conversations is a sound machine or radio that can be played to obscure other patient's conversations. However, this strategy requires the medical provider or staff to be active in turning the device on in order to obscure noises for privacy and likewise need to turn the noise generating device off in order to have a conversation with the current patient when it is their turn. The cycle continues with the staff and provider having to turn the privacy device on and off throughout the day. This seemingly small task often becomes overlooked and after time, it is simply left off and compliance with patient privacy (HIPPA) is lost. Violations of patient privacy are costly in terms of financial penalties as well as public relation problems.

Further, some know methods of soundproofing include speakers, permanently mounted in a building. The speakers are configured to play background noise, such as static, intended to drone out private conversations. Such known methods are unpleasant to listeners and are marginally effective in spaces where the unintended listener and the intended listener share a space (such as a common hospital room) and often involve expensive installation.

In light of the above discussion, there appears to be a need for an effective system that can employ methods for ensuring privacy of conversations/discussions.

### OBJECT OF INVENTION

The principle object of the embodiments herein is to use Near Field Communication to play audio/sound files that create a sound fog like effect thereby concealing inappropriate sounds and ensuring privacy of conversations.

Another object of the embodiments herein is to ensure patient privacy (HIPAA compliance).

### SUMMARY

The above-mentioned needs are met by a method, a non-transitory memory medium and a system for preventing overhearing of private conversations.

A method to obscure inappropriate sounds and ensure privacy in conversations through Near Field communication. The method includes applying a passive NFC tag on a first object associated to an individual who advances inside an enclosed area designed for a specific purpose. Further, the method includes activating an NFC reader on a second object when the first object and the second object are within a short range. Furthermore, the method includes sending a signal to a WIFI router wherein the signal speaks to a speaker module inside the enclosed area. Moreover, the method includes automatically streaming sound files, from a storage, thereby making it difficult for the individual inside the enclosed area to hear private conversations between two or more people due to a fogging sound effect produced by the sound files.

A non-transitory memory medium embodying computer executable program code configured to be executed by a processor, operably coupled to a speaker of a system, to cause the system to perform: applying a passive NFC tag on a first object associated to an individual who advances inside an enclosed area designed for a specific purpose; activating an NFC reader on a second object when the first object and the second object are within a short range; sending a signal to a WIFI router wherein the signal speaks to a speaker module inside the enclosed area; and automatically streaming sound files, from a storage, thereby making it difficult for the individual inside the enclosed area to hear private conversations between two or more people due to a fogging sound effect produced by the sound files.

A system to obscure inappropriate sounds and ensure privacy in conversations includes a passive NFC tag applied on a transmitting object, associated to an individual who advances into an enclosed area designed for a specific purpose. Further, the system includes an NFC reader on a second object placed outside the enclosed area and reads information stored on the NFC tag embedded in a sticker that is applied on the transmitting object. Furthermore, the system includes a speaker arrangement within the enclosed area, to stream sound files thereby making it difficult for the individual inside the enclosed area to hear private conversations between two or more people, wherein the sound files are produced to create a fogging sound effect.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1a and FIG. 1b illustrates an environment including an exemplary implementation operable to perform the various embodiments described herein;

FIG. 2 is a block diagram illustrating a speaker module communicating with the NFC reader and a server, according to the embodiments as disclosed herein; and

FIG. 3 is a flow diagram illustrating a method to provide prevent overhearing of private conversations, according to the embodiments as disclosed herein.

### DETAILED DESCRIPTION OF THE EMBODIMENTS

The above-mentioned needs are met by providing a method and system to prevent over-hearing of private conversations. Individuals who are engaged in conversations in a shared and/or public environment may be at risk of listening unintentionally to their conversations. Various embodiments provide the ability to produce sound waves (sound fog) to prevent overhearing of conversations that are perceived by surrounding and/or unintended recipients. It is to be noted that, although the method and system are intended to prevent overhearing of conversations, if an individual genuinely hears such conversations, the conversations are simply made unintelligible (muffled).

The following detailed description is intended to provide example implementations to one of ordinary skill in the art and is not intended to limit the invention to the explicit disclosure, as one of ordinary skill in the art will understand that variations can be substituted that are within the scope of the invention as described.

The invention described herein is primarily implemented in a medical setting (hospital room). However, those skilled in the art, upon reading this disclosure, will appreciate that the invention may be implemented in several other places/setting where privacy is desired, such as and not limited to, law offices, accounting offices, government facilities, military setting, hotel rooms, public places which are specifically provided by businesses, private portions of jailhouses and other shared environments.

As used herein, two objects who are configured with NFC devices are referred to as a “first object” and a “second object”. Specifically, the “first object” is referred to the object that is set up with an NFC tag and the “second object” is referred to the object that is set up with an NFC reader.

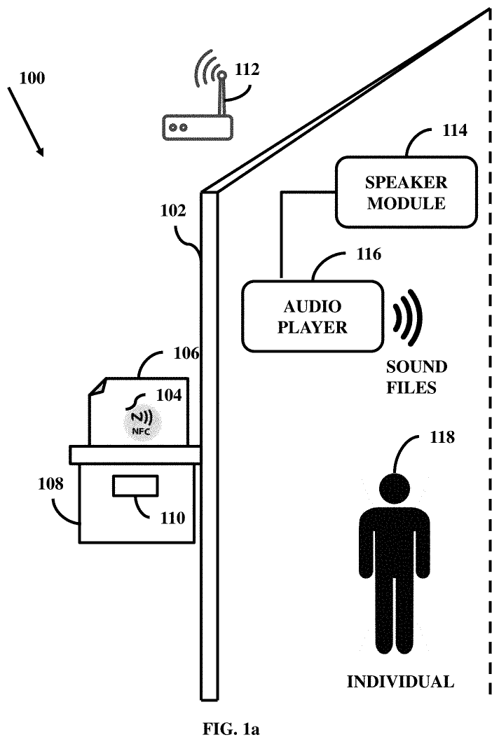

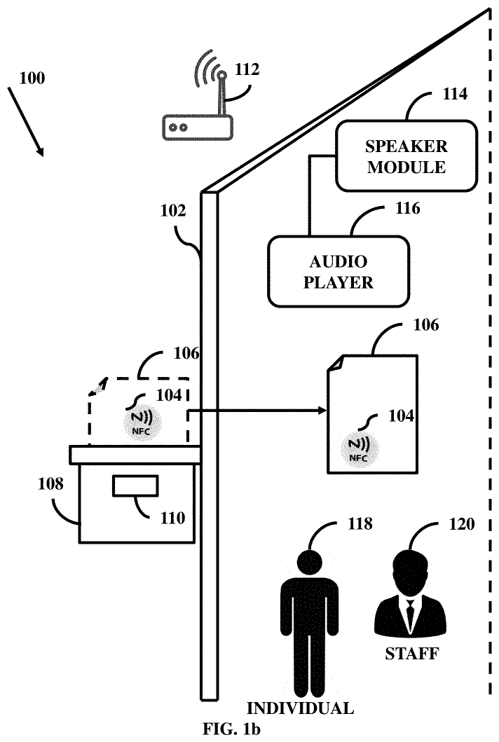

FIG. 1a and FIG. 1b illustrates an environment including an exemplary implementation operable to perform the various embodiments described herein. The environment 100 includes an enclosed area 102 that is used for a specific purpose, an NFC tag 104, a first object 106, a second object 108, an NFC reader 110, a WIFI Router 112, a speaker module 114, an audio player 116 and an individual 118. Additionally, the environment 100 illustrated in FIG. 1b includes a member of staff personnel 120.

The enclosed area 102 is typically a dedicated room with thin-walled structures that allow sound waves to pass through them. Such rooms are liable for overhearing private conversations. For the purposes of the disclosed invention, the enclosed area 102 is an exam room in a medical setting. Specifically, the exam room is a small room in a hospital where a physician may examine a patient with some privacy.

The NFC tag 104 and NFC reader 110 are devices that communicate through Near Field Communication (NFC). NFC is a set of standards that allow devices to communicate through radio signals when they are held in close proximity. Further, the NFC tag 104 is a small sticker applied on the first object 106 that contains a small unpowered NFC chip.

As mentioned above, the invention described herein is primarily applied in a medical setting for practical purposes. Many medical offices use a reusable folder containing paperwork associated to a patient such as lab, x-ray or pathology notes. Even with current electronic medical records, the folders are still in use and may simply have a coversheet with the patient's name for taking down notes. The second object 108 is placed just outside the exam room. The second object 108 is typically a basket fixed to the wall in which the first object 106 is placed. The NFC tag 104 is applied to the first object 106 which can be a folder/file in the medical setting. The NFC reader 110, when activated by the NFC tag 104, reads the information stored in the NFC tag 104. The information stored in the NFC tag 104 is specific to the staff.

The WIFI Router 112 may be located outside the enclosed area 102. It is a device that enables wireless packet forwarding and routing. It is used to provide access to the Internet.

The speaker module 114 is placed inside the enclosed area 102 and receives the signal from the WIFI Router 112. It should be appreciated that embodiments of the speaker module 114 may include more elements than depicted in FIG. 1a and FIG. 1b.

The audio player 116 is an electronic device (media player), such as an MP3 player, used to play the sound files (or digital audio files) and may/may not be configured within the speaker module 114. The sound files may be music or speech. In some embodiments the audio player 116 may be positioned in a place (within the enclosed area) where privacy of conversations is desired. For example, in some embodiments, the audio player can be configured to be placed on a table, wall mounted, ceiling mounted, and/or positioned by any other suitable means. The sound files are stored on a memory chip in the audio player 116.

It is to be noted that, the WIFI Router 112, speaker module 114 and audio player 116 may be together referred to “speaker arrangement”.

The individual 118 is a patient in the medical setting as described above. Similarly, the staff 120 (illustrated in FIG. 1b) is a person related to setting. For instance, the staff 120 in a medical setting may refer to a doctor, medical provider or a healthcare professional.

Referring to FIG. 1b, the individual 118 is brought to the enclosed area 102 and is asked to sit inside until the staff 120 arrives. The first object 106 associated to the individual 118 is taken out of the second object 108. An NFC tag 104 is applied to the first object 106 and in practice, is made to touch or tap the NFC reader, placed inside the second object 108. This arrangement initiates the NFC tag 104 to activate the NFC reader 110 which in turn sends a signal to the WIFI Router 112. The WIFI Router 112 further communicates automatically to the speaker module 114 inside the enclosed area 102. As a result, sound files are streamed from the audio player 116, as the individual waits alone in the enclosed area 102. The sound files would make it difficult for the individual to overhear other people's conversations.

It is to be noted that, in some embodiments the audio player 116 may be transformed in order to stream audio and/or visual files.

Now referring to FIG. 1b, upon arrival of the staff 120, the individual's associated first object 106 is lifted out of the second object 108 and is taken into the enclosed area 102. This illustrates that the NFC tag 104 is not activating the NFC reader 110. As a result, the speaker module 114 is turned off and the streaming of sound files terminates.

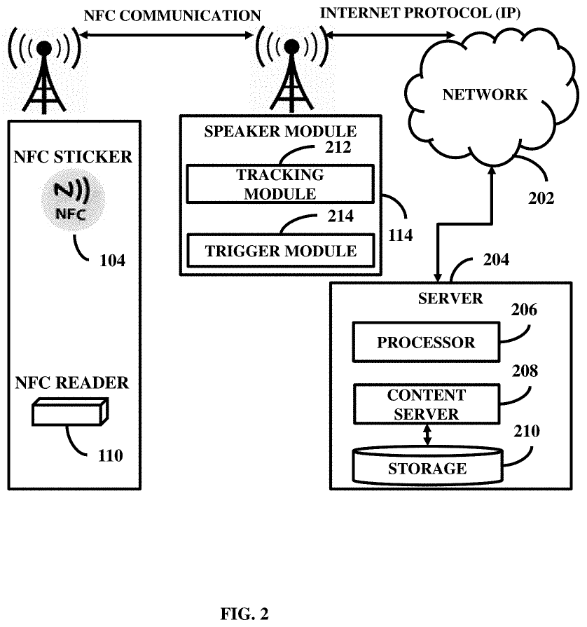

FIG. 2 is a block diagram illustrating a speaker module communicating with the NFC reader and a server, according to the embodiments as disclosed herein.

The system implemented to apply the method described herein may be referred to as “SoundFog”. The SoundFog system is based on Near Field Communications and a WIFI router.

The NFC tag 104 and NFC reader 110 are near field communication passive devices. The NFC reader 110 includes a near field communication interface which retrieves information from the NFC tag 104. They are pre-programmed with a unique Universal Resource Locator (URL) and is identified in the server 204 through the network 202.

Examples of the network 202 include, but are not limited to, wireless network, wire line network, public network such as the Internet, Intranet, private network, General Packet Radio Network (GPRS), Local Area Network (LAN), Wide Area Network (WAN), Metropolitan Area Network (MAN), cellular network, Public Switched Telephone Network (PSTN), personal area network, and the like. The network 202 can be operable with cellular networks, Bluetooth network, Wi-Fi networks, or any other networks or combination thereof.

The server 204 includes the processor 206, content server 208 and a storage 210. The processor 206 is configured with a non-transitory computer-readable medium, the contents of which cause it to perform the method disclosed herein.

The content server 208 manages web content, which typically includes sound files/audio files for the purposes of the method disclosed herein. Further, the content server 208 may index content or deliver content in a requested way, such as based on category.

The storage 210 may comprise for example a database to store sound/audio files.

Referring to FIG. 2, the server 204 correlates the unique identifier of the RFC tag as a request is received from the speaker module over the network using Internet Protocol (IP) to stream sound files.

Further, the speaker module 114 includes a tracking module 212 and trigger module 214. The tracking module 212 tracks the duration of time the sound files streams between shut off and the number of cycles. This data can be reviewed to reveal the average wait times of individuals. Further, the trigger module 214 is accountable to automatically adjust one or more parameters of the sound files.

It should be appreciated by those of ordinary skill in the art that FIG. 2 depicts the server in an oversimplified manner and a practical embodiment may include additional components and suitably configured processing logic to support known or conventional operating features that are not described in detail herein.

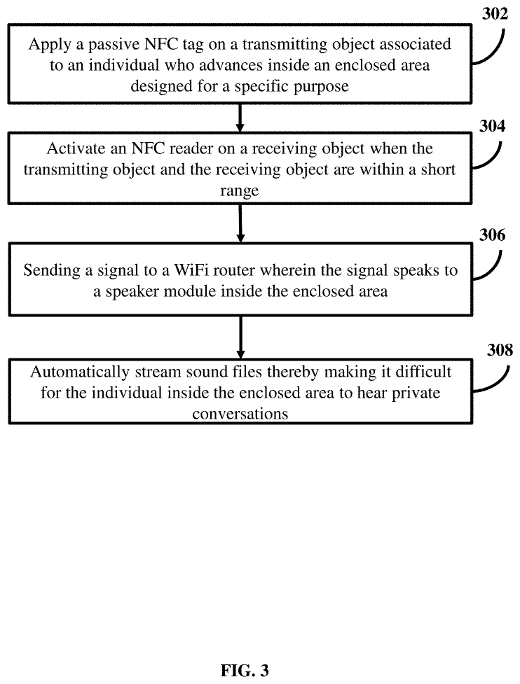

FIG. 3 is a flow diagram illustrating a method to provide prevent overhearing of private conversations, according to the embodiments as disclosed herein. The flow diagram begins at step 302.

At step 302, a passive NFC tag is applied to a first object associated to an individual who advances inside an enclosed area designed for a specific purpose.

The individual is asked to wait inside the enclosed area until a staff arrives. The NFC tag can be an NFC sticker which contains a small unpowered NFC chip that is applied on the first object and subsequently placed next to the second object. An NFC reader is configured on the second object. This arrangement of the RFC sticker and RFC reader enables Near Field Communication between the first object and second object.

At step 304, an NFC reader on a second object is activated when the first object and the second object are within a short range/close proximity.

The first object and second object are both placed outside the enclosed area.

At step 306, a signal is sent to a WIFI router wherein the signal communicates to a speaker module inside the enclosed area. The speaker module turns “ON”.

At step 308, automatically stream sound files thereby making it difficult for the individual inside the enclosed area to hear private conversations.

The sound files are streamed from a storage, such as a database, and producing a fogging sound effect. The sounds obfuscate the conversations so that the conversations become unintelligible to unintended listeners. This makes it difficult for the individual to overhear conversations as he/she waits in the enclosed area. The Health Insurance Portability and Accountability Act (HIPAA) mandates that individually identifiable patient health information be protected.

The method described herein, allows the sound files to change its content at ease. Typically, the sound files include one or more segments of music, advertisements, informative and educational records. Further, sound files are staff specific. In other words, the segments may be specific to a staff. For instance, if the enclosed area is used by a pediatrician on Monday and a cardiologist on Wednesday then, on Monday NFC stickers would signal to play age appropriate music for a pediatric population. Similarly, on Wednesday the NFC stickers would signal to play educational programming regarding mitigating cardiac risk factors.

An additional feature of the method described herein is the implementation of triggers that automatically adjust the coordinated sound based on several elements such as pitch, beat, tempo, allocation of voices, color, expression, and structure.

When the staff arrives, the first object is taken into the enclosed area. As a result, the RFC reader is deactivated and simultaneously the streaming of sound files is silenced/stopped automatically as the speaker module turns “OFF”.

The method described herein facilitates tracking the time duration of the streamed sound files between each deactivation of the NFC reader. Further, the number of cycles of streaming the sound files are also recorded. The data collected during the tracking phase reports the average wait times of individuals who waited in the enclosed area.

The flow diagram ends at step 308.

It should be appreciated to those skilled in the art that, although the method described herein is implemented in the field of Near Field Communication, other channels may also be applied. The other channels include, but is not limited to, laser light interruption, magnetic sensing, weight-based activation, Bluetooth and motion detection.

It is to be noted that the method described herein may be implemented across various application areas as listed below:

Medical Field: A patient is asked to wait inside the exam room until a doctor or a healthcare person arrives. The NFC sticker is applied on a medical folder and is placed in a basket just outside the door. The basket holds the RFC reader. As the patient waits alone in the exam room, the medical folder remains in the basket, thereby activating the RFC reader such that sound is played inside the exam room. This makes it difficult for the patient to overhear private conversations. Such conversations may include sensitive medical and/or patient information. Later, when the doctor/healthcare person arrives, the medical folder is taken out of the basket and into the exam room. With the medical folder out of the basket, the NFC sticker deactivates the NFC reader and the sound inside the exam room is put off.

Based on the medical office, dynamics of the medical office flow may vary. For instance, if a medical folder is not used and a portable computer laptop is brought and is placed on a docking station. The NFC sticker is placed on the computer and an NFC reader is attached to the docking station. In such a scenario, when the computer laptop is docked to the docking station, it represents that the doctor/healthcare person is in the room and that there is a need for silence during the conversation. This arrangement would entail that the NFC sticker on the computer laptop would cause the music/speech to go silent when near the NFC reader (when the computer laptop was docked inside of the exam room). Further, this arrangement works with the flow of the current medical office in the background to ensure patient privacy (HIPPA compliance).

Restaurant: A waiter may want the audio above his table to be automatically diminished when he arrives to take food/cocktail order.

Outlets/Showrooms: A car saleswoman may want ads to be played when she exits the room to talk to her supervisor and for them to automatically go silent on her return.

Various modifications and variations of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the claims.

Accordingly, the disclosure of the present invention is intended to be illustrative, but not limiting, of the scope of the invention, which is set forth in the following claims.

1. A method to obscure inappropriate sounds and ensure privacy in conversations, the method comprising:
applying a passive NFC tag on a first object associated to an individual who advances inside an enclosed area designed for a specific purpose;
activating an NFC reader on a second object when the first object and the second object are within a short range;
sending a signal to a WIFI router wherein the signal communicates to a speaker module inside the enclosed area; and
automatically streaming sound files, from a storage, thereby making it difficult for the individual inside the enclosed area to hear private conversations between two or more people due to a fogging sound effect produced by the sound files.

2. The method of claim 1, wherein the individual waits for a staff to enter the enclosed area.

3. The method of claim 1, wherein the first object and second object are placed outside the enclosed area.

4. The method of claim 1 and further comprising:
deactivating the NFC reader when the first object is taken into the enclosed area by the staff; and
silencing the sound files in response to the staff accompanying the individual inside the enclosed area consequently turning off the speaker module automatically.

5. The method of claim 1 and further comprising:
tracking the time duration of streaming the sound files between each deactivation of the NFC reader and the number of cycles of streaming the sound files; and
reviewing the data tracked thereby reporting the average wait times of individuals who waited in the enclosed area.

6. The method of claim 1 and further comprising:
permitting changes in the sound files, wherein the sound files includes one or more segments of music, advertisements, informative and educational records.

7. The method of claim 1 and further comprising:
streaming sound files specific to the staff who employs the enclosed area at a prearranged day and time.

8. The method of claim 1 and further comprising:
triggering automatically to adjust one or more parameters associated to the sound files.

9. A non-transitory memory medium embodying computer executable program code configured to be executed by a processor, operably coupled to a speaker of a system, to cause the system to perform:
applying a passive NFC tag on a first object associated to an individual who advances inside an enclosed area designed for a specific purpose;
activating an NFC reader on a second object when the first object and the second object are within a short range;
sending a signal to a WIFI router wherein the signal communicates to a speaker module inside the enclosed area; and
automatically streaming sound files, from a storage, thereby making it difficult for the individual inside the enclosed area to hear private conversations between two or more people due to a fogging sound effect produced by the sound files.

10. A system to obscure inappropriate sounds and ensure privacy in conversations, the system comprising:
a passive NFC tag applied on a transmitting object, associated to an individual who advances into an enclosed area designed for a specific purpose;
an NFC reader on a second object placed outside the enclosed area and reads information stored on the NFC tag embedded in a sticker that is applied on the transmitting object; and
a speaker arrangement within the enclosed area, to stream sound files thereby making it difficult for the individual inside the enclosed area to hear private conversations between two or more people, wherein the sound files are produced to create a fogging sound effect.

11. The system of claim 10, wherein the speaker arrangement comprises:
a WIFI router that receives the signal from the NFC reader and converts the data stream from the signal into radio signals, the radio signals are then transmitted to an audio player;
a speaker module, operatively connected to a processor, that receives the radio signals from the WIFI Router, when the individual is inside the enclosed area; and
the audio player that streams the sound files in response to the speaker module receiving the radio signals, wherein the sound files represent differing segments that can be changed based on prearranged date and time.

12. The system of claim 10, wherein the NFC reader is activated when the first object with the NFC tag is located outside the enclosed area.

13. The system of claim 10 and further comprising:
a tracking module to track the duration of time the sound files streams between shut off and the number of cycles, thereby reviewing the tracked data to reveal the average wait times of individuals; and
a trigger module to automatically adjust one or more parameters of the sound files.

14. The system of claim 10 and further comprising:
a backend storage to collect the sound files to be streamed.
